(19) United States
(12) Patent Application Publication
(10) Pub. No.: US 2022/0112681 A1
(43) Pub. Date: Apr. 14, 2022

(54) REPRODUCTION DEVICE, ANALYSIS ASSISTANCE SYSTEM, AND REPRODUCTION METHOD

(71) Applicant: KOMATSU LTD., Tokyo (JP)

(72) Inventors: Shintaro HAMADA, Tokyo (JP); Yoshiyuki ONISHI, Tokyo (JP); Mitsuhiro AOKI, Tokyo (JP)

(21) Appl. No.: 17/264,443

(22) PCT Filed: Aug. 16, 2019
(86) PCT No.: PCT/JP2019/032099

§ 371 Date: Jan. 29, 2021

(30) Foreign Application Priority Data
Sep. 14, 2018 (JP) 2018-172845

(51) Int. Cl. E02F 3/43; E02F 9/26

(52) U.S. Cl. CPC E02F 3/438; E02F 3/437; E02F 9/265

(57) ABSTRACT

A reproduction device includes an acquisition unit, a reception unit, and a reproduction unit. The acquisition unit acquires log information including angle information of a movable part of a work machine. The log information is associated with time. The reception unit receives a reproduction instruction usable to reproduce a movement of the work machine. The reproduction unit reproduces the movement of the work machine by sequentially applying the angle information to a work machine model upon receiving the reproduction instruction.

### CROSS-REFERENCE TO RELATED APPLICATIONS

This application is a U.S. National stage application of International Application No. PCT/JP2019/032099, filed on Aug. 16, 2019. This U.S. National stage application claims priority under 35 U.S.C. § 119(a) to Japanese Patent Application No. 2018-172845, filed in Japan on Sep. 14, 2018, the entire contents of which are hereby incorporated herein by reference.

### BACKGROUND

### Field of the Invention

The present invention relates to a reproduction device, an analysis assistance system, and a reproduction method.

### Background Information

Japanese Unexamined Patent Application, First Publication No. 2016-089388 discloses a work support image generation device that can generate a support image which supports work of a manipulator and includes relative position information between a work machine and a transport vehicle without disposing a dedicated camera-equipped vehicle on a site, and a remote control system of the work machine provided with the work support image generation device.

### SUMMARY

In the field related to the driving and operation of work machines, there are needs such as wanting to look back on one's own operation, wanting to know the movement of a skilled manipulator, and wanting to know the movement of a work machine at the time of failure or abnormality of the work machine. Therefore, there is demand for development of a tool that can analyze the movement of the work machine in detail by precisely reproducing the movement of the work machine based on an operation of a manipulator.

In view of the problem described above, an object of the present invention is to provide a reproduction device, an analysis assistance system, and a reproduction method capable of reproducing, on a screen, a series of movements of a work machine based on an operation of a manipulator of the work machine and analyzing the movements after the fact.

According to an aspect of the present invention, a reproduction device includes an acquisition unit that acquires log information that includes angle information of a movable part of a work machine, which is associated with time, a reception unit that receives a reproduction instruction of reproducing a movement of the work machine, and a reproduction unit that reproduces the movement of the work machine by sequentially applying the angle information to a work machine model when receiving the reproduction instruction.

According to the aspect, the movement of the work machine based on the operation of the manipulator can be reproduced and analyzed on a screen.

### BRIEF DESCRIPTION OF DRAWINGS

FIG. 1 is a diagram showing an overall configuration of an analysis assistance system according to a first embodiment.

FIG. 2 is a diagram showing a structure of a work machine according to the first embodiment.

FIG. 3 is a diagram showing a configuration of a cab of the work machine according to the first embodiment.

FIG. 4 is a diagram showing a functional configuration of a reproduction device according to the first embodiment.

FIG. 5 is a diagram showing a processing flow of the reproduction device according to the first embodiment.

FIG. 6 is a first diagram showing an example of log information according to the first embodiment.

FIG. 7 is a second diagram showing an example of the log information according to the first embodiment.

FIG. 8 is a third diagram showing an example of the log information according to the first embodiment.

FIG. 9 is a diagram showing an example of a work machine model according to the first embodiment.

FIG. 10 is a diagram showing an example of a display image according to the first embodiment.

FIG. 11 is a diagram showing a processing flow of a reproduction device according to another embodiment.

### DETAILED DESCRIPTION OF EMBODIMENT(S)

### First Embodiment

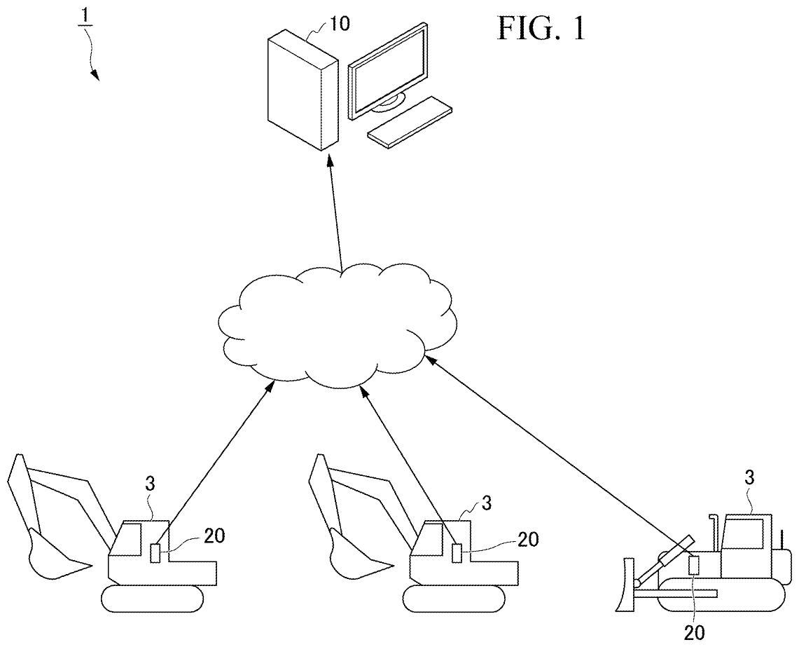

Hereinafter, a reproduction device and an analysis assistance system that includes the reproduction device according to a first embodiment will be described in detail with reference to FIGS. 1 to 10.

### (Overall Configuration of Analysis Assistance System)

FIG. 1 is a diagram showing the overall configuration of the analysis assistance system according to the first embodiment.

An analysis assistance system 1 has a reproduction device 10, and a data logger 20 mounted on each of a plurality of work machines 3.

The work machine 3 is a target of work analysis by the reproduction device 10. Examples of the work machine 3 include a hydraulic excavator, a wheel loader, and the like. In the following description, description will be made by taking a hydraulic excavator as an example of the work machine 3. Each work machine 3 is provided with a plurality of sensors. The data logger 20 records and accumulates information indicating the state of the work machine 3 acquired by the sensors, in chronological order. Hereinafter, the information indicating the state of the work machine 3 at each time and recorded by the data logger 20 is also described as log information. Further, the data logger 20 transmits the recorded log information to the reproduction device 10 through a wide area communication network at a fixed time interval. The fixed time interval is, for example, a 5-minute interval. The reproduction device 10 records the log information received from the data logger 20 on a recording medium.

The function of the reproduction device 10 will be described later.

### (Structure of Work Machine)

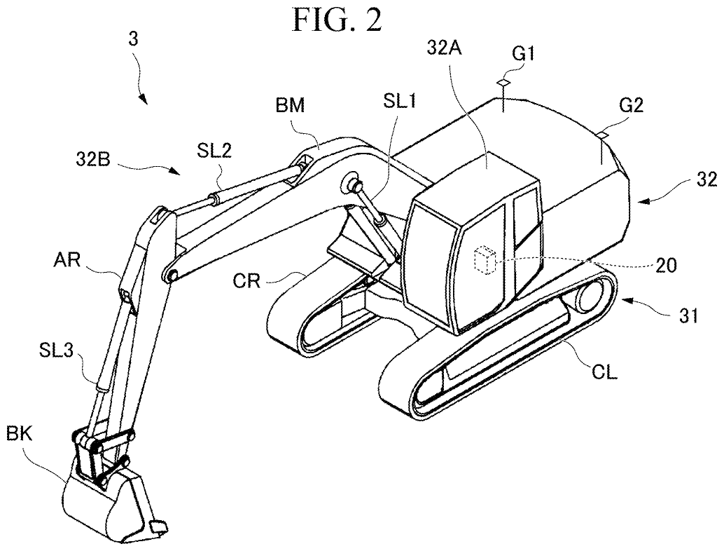

FIG. 2 is a diagram showing the structure of the work machine according to the first embodiment.

The work machine 3 which is a hydraulic excavator excavates and levels earth and the like at a work site or the like.

As shown in FIG. 2, the work machine 3 which is a hydraulic excavator has an undercarriage 31 for traveling, and an upper swing body 32 which is installed at an upper portion of the undercarriage 31 and can be swung. Further, the upper swing body 32 is provided with a cab 32A, work equipment 32B, and two GPS antennas G1 and G2.

The undercarriage 31 has a left crawler CL and a right crawler CR. The work machine 3 moves forward, swings, and moves backward by the rotation of the left crawler CL and the right crawler CR.

The cab 32A is a place where a manipulator of the work machine 3 boards and performs an operation. The cab 32A is installed, for example, at a left side portion of a front end portion of the upper swing body 32. The internal configuration of the cab 32A will be described later.

The work equipment 32B includes a boom BM, an arm AR, and a bucket BK. The boom BM is mounted to the front end portion of the upper swing body 32. Further, the arm AR is attached to the boom BM. Further, the bucket BK is attached to the arm AR. Further, a boom cylinder SL1 is mounted between the upper swing body 32 and the boom BM. The boom BM can be moved with respect to the upper swing body 32 by driving the boom cylinder SL1. An arm cylinder SL2 is mounted between the boom BM and the arm AR. The arm AR can be moved with respect to the boom BM by driving the arm cylinder SL2. A bucket cylinder SL3 is mounted between the arm AR and the bucket BK. The bucket BK can be moved with respect to the arm AR by driving the bucket cylinder SL3.

The upper swing body 32, the boom BM, the arm AR, and the bucket BK which are included in the work machine 3 which is a hydraulic excavator are movable parts of the work machine 3 according to one aspect.

### (Configuration of Cab)

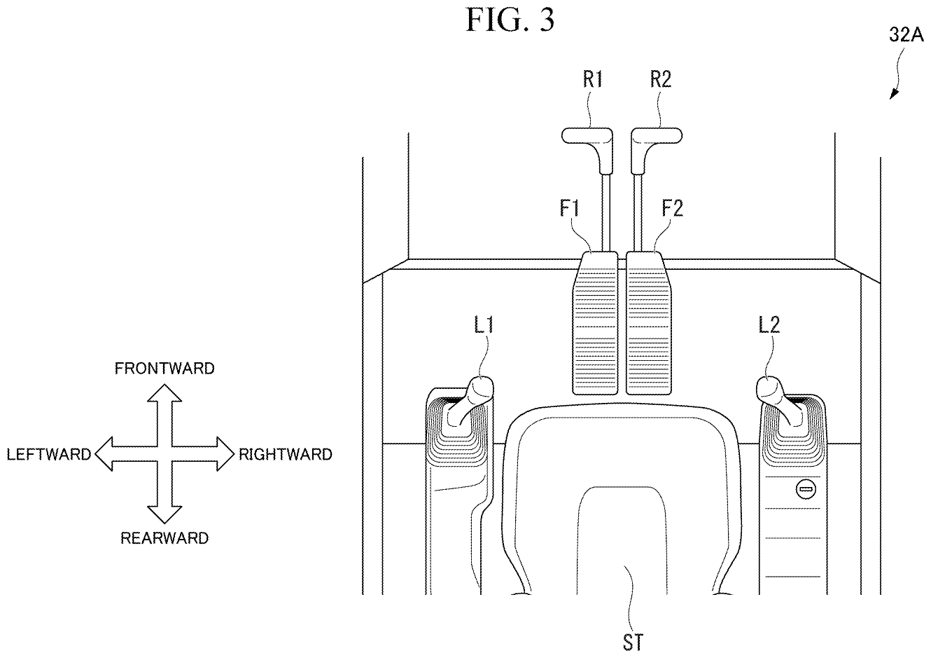

FIG. 3 is a diagram showing the configuration of the cab of the work machine according to the first embodiment.

As shown in FIG. 3, the cab 32A is provided with operating levers L1 and L2, foot pedals F1 and F2, and traveling levers R1 and R2.

The operating lever L1 and the operating lever L2 are disposed on the left and right sides of a seat ST in the cab 32A. Further, the foot pedal F1 and the foot pedal F2 are disposed on a floor surface in front of the seat ST in the cab 32A.

An example of an operation pattern showing a correspondence relationship between input operations to the operating levers L1 and L2 and the traveling levers R1 and R2 and the movement of the work machine 3 which is a hydraulic excavator is as follows.

The operating lever L1 disposed on the left side when facing the front of the cab is an operating mechanism for performing a swing operation of the upper swing body 32 and excavation and dump operations of the arm AR. Specifically, when the manipulator of the work machine 3 tilts the operating lever L1 forward, the arm AR performs the dump operation. Further, when the manipulator of the work machine 3 tilts the operating lever L1 rearward, the arm AR performs the excavation operation. Further, when the manipulator of the work machine 3 tilts the operating lever L1 in the rightward direction, the upper swing body 32 performs rightward swing. Further, when the manipulator of the work machine 3 tilts the operating lever L1 in the leftward direction, the upper swing body 32 performs leftward swing. The upper swing body 32 may perform the rightward swing or the leftward swing when the operating lever L1 is tilted in a front-rear direction, and the arm AR may perform the dump operation or the excavation operation when the operating lever L1 is tilted in a left-right direction.

The operating lever L2 disposed on the right side when facing the front of the cab is an operating mechanism for performing excavation and dump operations of the bucket BK and raising and lowering operations of the boom BM. Specifically, when the manipulator of the work machine 3 tilts the operating lever L2 forward, the lowering operation of the boom BM is performed. Further, when the manipulator of the work machine 3 tilts the operating lever L2 rearward, the raising operation of the boom BM is performed. Further, when the manipulator of the work machine 3 tilts the operating lever L2 in the rightward direction, the bucket BK performs the dump operation. Further, when the manipulator of the work machine 3 tilts the operating lever L2 in the leftward direction, the bucket BK performs the excavation operation.

Further, the traveling levers R1 and R2 are operating mechanisms for performing the operation control of the undercarriage 31, that is, the traveling control of the work machine 3.

The traveling lever R1 disposed on the left side when facing the front of the cab corresponds to the rotational drive of the left crawler CL of the undercarriage 31. Specifically, when the manipulator of the work machine 3 tilts the traveling lever R1 forward, the left crawler CL rotates in a forward movement direction. Further, when the manipulator of the work machine 3 tilts the traveling lever R1 rearward, the left crawler CL rotates in a backward movement direction.

The traveling lever R2 disposed on the right side when facing the front of the cab corresponds to the rotational drive of the right crawler CR of the undercarriage 31. Specifically, when the manipulator of the work machine 3 tilts the traveling lever R2 forward, the right crawler CR rotates in a forward movement direction. Further, when the manipulator of the work machine 3 tilts the traveling lever R2 rearward, the right crawler CR rotates in a backward movement direction. The foot pedals F1 and F2 are interlocked with the traveling levers R and R2, respectively, and traveling control can also be performed by the foot pedals F1 and F2.

The operation pattern described above is only an example, and is not limited to the above aspect depending on the model or the like of the hydraulic excavator.

Depending on an embodiment, the work machine 3 described using FIG. 2 may not necessarily be provided with the GPS antennas G1 and G2.

### (Functional Configuration of Reproduction Device)

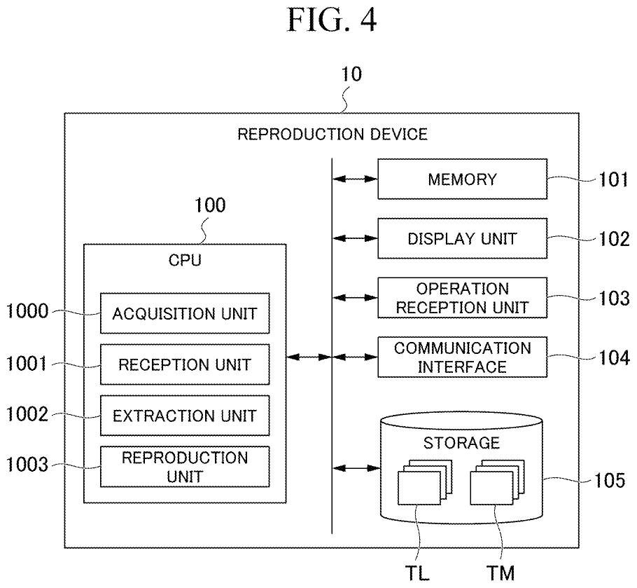

FIG. 4 is a diagram showing the functional configuration of the reproduction device according to the first embodiment.

Hereinafter, the function of the reproduction device 10 according to the first embodiment will be described with reference to FIG. 4.

As shown in FIG. 4, the reproduction device 10 includes a CPU 100, a memory 101, a display unit 102, an operation reception unit 103, a communication interface 104, and a storage 105. The CPU 100 may be a processor such as FPGA or GPU instead of a CPU.

The CPU 100 is a processor that controls the entire operation of the reproduction device 10. Various functions of the CPU 100 will be described later.

The memory 101 is a so-called main storage device. A command and data necessary for the CPU 100 to operate based on a program are expanded in the memory 101.

The display unit 102 is a display device capable of visually displaying information and is, for example, a liquid crystal display, an organic EL display, or the like.

The operation reception unit 103 is an input device and is, for example, a general mouse, keyboard, touch sensor, or the like.

The communication interface 104 is a communication interface for communicating with the data logger 20.

The storage 105 is a so-called auxiliary storage device and is, for example, Hard Disk Drive (HDD), Solid State Drive (SSD), or the like. Log information TL received from the data logger 20, a work machine model TM prepared in advance for each vehicle type and each model of the work machine 3, and the like are recorded in the storage 105. The work machine model TM will be described later.

The functions of the CPU 100 of the reproduction device 10 according to the first embodiment will be described in detail. The CPU 100 operates based on a predetermined program to exhibit functions as an acquisition unit 1000, a reception unit 1001, an extraction unit 1002, and a reproduction unit 1003.

The predetermined program may be a program for realizing a part of the function to be exhibited by the reproduction device 10. For example, the program may exhibit a function by a combination with another program already stored in the storage 105, or a combination with another program installed in another device. In another embodiment, the reproduction device 10 may include a custom Large Scale Integrated Circuit (LSI) such as a Programmable Logic Device (PLD) in addition to or instead of the above configuration. Examples of the PLD include Programmable Array Logic (PAL), Generic Array Logic (GAL), Complex Programmable Logic Device (CPLD), and Field Programmable Gate Array (FPGA). In this case, some or all of the functions realized by the processor may be realized by the integrated circuit.

The acquisition unit 1000 acquires the log information TL to be reproduced, from among a plurality of sets of log information TL recorded and accumulated in the storage 105. The plurality of sets of log information TL are recorded in the storage 105 for each file recorded with an individual file name.

The reception unit 1001 receives a predetermined reproduction instruction from an operator of the reproduction device 10. For example, the reception unit 1001 receives a reproduction instruction of reproducing the work machine 3 from the operator of the reproduction device 10.

The extraction unit 1002 extracts information to be used for reproduction of the work machine 3, from the acquired log information TL.

The reproduction unit 1003 applies the extracted angle information of the work machine 3 to the work machine model TM corresponding to the work machine 3 and reproduces the work machine model TM.

### (Processing Flow of Reproduction Device)

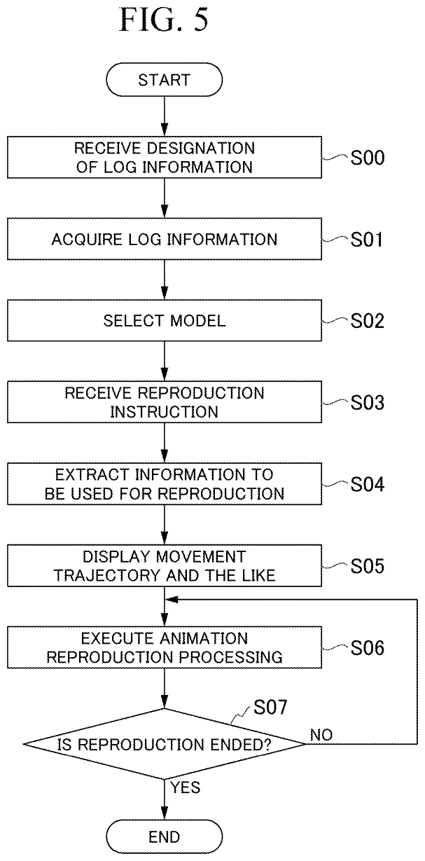

FIG. 5 is a diagram showing a processing flow of the reproduction device according to the first embodiment.

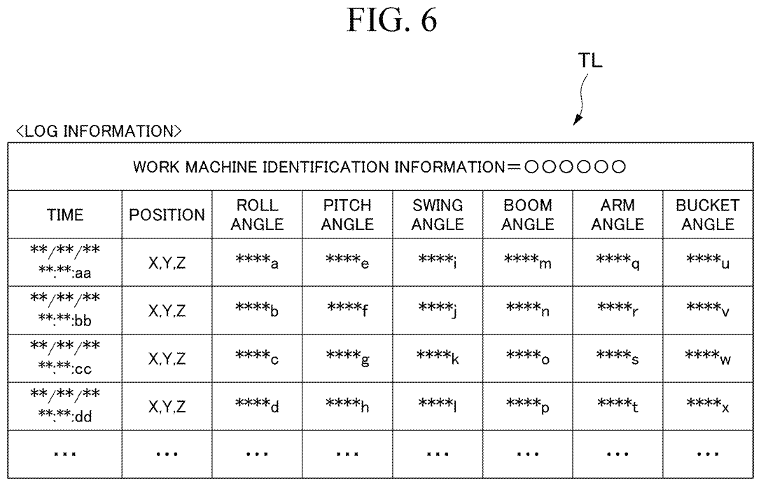

FIGS. 6 to 8 are first to third diagrams showing examples of the log information according to the first embodiment.

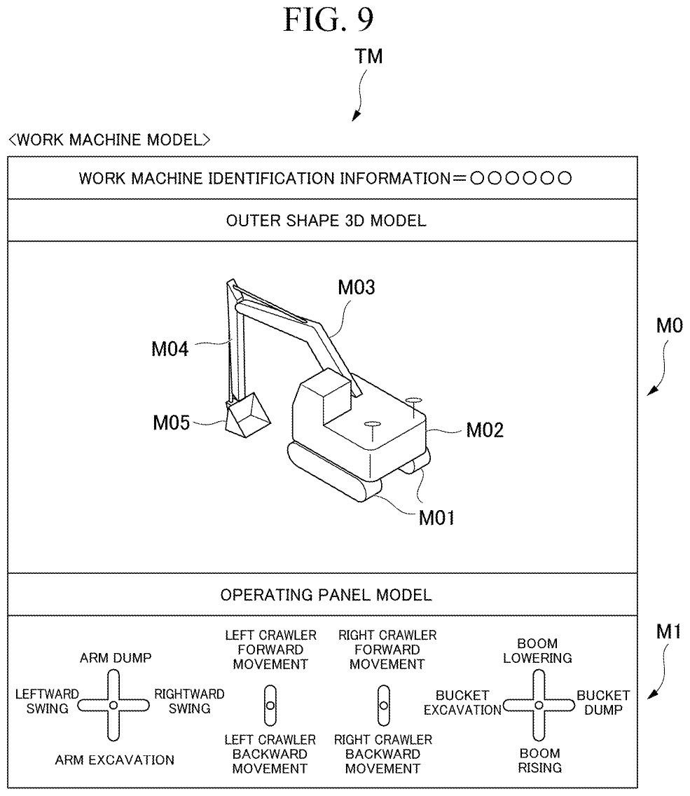

FIG. 9 is a diagram showing an example of the work machine model according to the first embodiment.

Hereinafter, a flow of specific processing which is performed by the reproduction device 10 will be described in detail with reference to FIGS. 5 to 9.

The processing flow shown in FIG. 5 is started from a point in time when a dedicated application is started by the operator of the reproduction device 10.

When the dedicated application is started by the operation of the operator, the reception unit 1001 of the CPU 100 receives the designation of the log information TL to be reproduced (step S00). The operator of the reproduction device 10 designates the log information TL to be reproduced, by inputting for example, a file name or the like of the log information TL. The log information TL to be reproduced may be fixed, and the designation of the log information TL may be omitted.

Here, the log information TL will be described with reference to FIGS. 6 to 8.

As shown in FIGS. 6 to 8, work machine identification information is included in the log information TL. Specifically, the work machine identification information includes individual identification numbers for individually identifying the work machines 3. The work machine identification information is assigned so as to correspond to the vehicle type, model, type, machine number, or the like of the work machine 3 representing a hydraulic excavator, a wheel loader, or the like.

As shown in FIG. 6, the log information TL includes information indicating the position and posture of the work machine 3 at each time, and angle information of the movable parts of the work machine 3. Specifically, the position of the work machine 3, a roll angle of the work machine 3 which is the tilt of the machine body in the left-right direction, a pitch angle which is the tilt of the machine body in the front-rear direction, a swing angle, a boom angle, an arm angle, and a bucket angle are recorded for each time in the log information TL. Here, the data logger 20 installed in the work machine 3 specifies and records the position of the work machine 3, based on positioning information which is obtained, for example, by receiving signals from the GPS antennas G1 and G2 and indicates the latitude and longitude of the work machine 3. Further, the data logger 20 calculates and records the roll angle and pitch angle of the work machine 3, based on the measurement result by an Inertial Measurement Unit (IMU) installed in the work machine 3. Further, the data logger 20 calculates and records the swing angle of the upper swing body 32, based on positioning information which is obtained from the GPS antennas G1 and G2 provided at the upper swing body 32. Further, the data logger 20 calculates and records the boom angle, the arm angle, and the bucket angle, based on the expansion and contraction degrees of the boom cylinder SL1, the arm cylinder SL2, and the bucket cylinder SL3, respectively.

The position, the roll angle, and the pitch angle are information necessary for specifying the position and posture of the work machine 3 itself. Therefore, for example, in an embodiment in which only the movements of the movable parts of the work machine 3, that is, the movements of the upper swing body 32, the boom BM, the arm AR, and the bucket BK, are reproduced by animation and the position and posture of the work machine 3 itself are not reproduced, the information on the position, the roll angle, and the pitch angle does not need to be included in the log information.

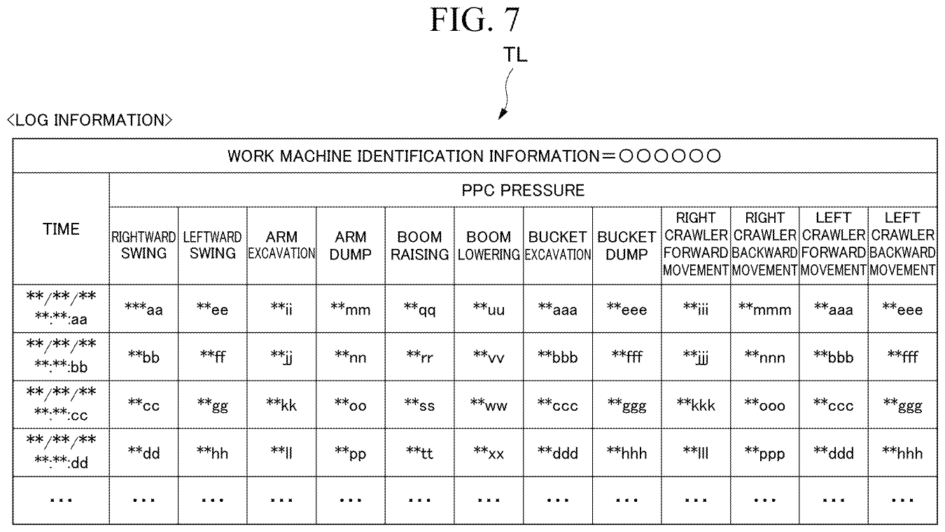

Further, as shown in FIG. 7, the log information TL includes pilot hydraulic pressures (PPC pressures) indicating the degrees of input to the operating levers L1 and L2 and the like by the manipulator at each time, that is, the degree of tilt of the lever and the degree of pedal depression. Specifically, the PPC pressures of the operating levers L1 and L2, the traveling levers R1 and R2, and the foot pedals F1 and F2 corresponding to the respective operation types of the leftward/rightward swing, the excavation/dump of the arm, the raising/lowering of the boom, the excavation/dump of the bucket, the forward movement/backward movement of the right crawler, and the forward movement/backward movement of the left crawler by the manipulator are recorded at each time in the log information TL. The time shown in FIG. 7 corresponds to the time shown in FIG. 6.

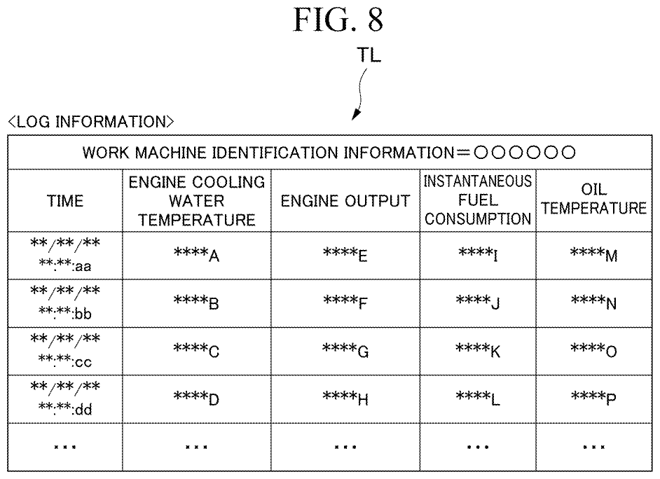

Further, as shown in FIG. 8, the log information TL includes information indicating the status of a major drive mechanism such as an engine or a hydraulic pump of the work machine 3 at each time. Specifically, a cooling water temperature of the engine, engine output, an instantaneous fuel consumption, and an oil temperature of the hydraulic pump are recorded for each time in the log information TL. The time shown in FIG. 8 corresponds to the time shown in FIGS. 6 and 7.

Returning to FIG. 5, when receiving the designation of the log information TL by the operator of the reproduction device 10 in step S00, the acquisition unit 1000 of the CPU 100 expands the designated log information TL in the memory 101 and acquires it (step S01). Next, the acquisition unit 1000 refers to the work machine identification information included in the log information TL. The acquisition unit 1000 selects and reads out the work machine model TM corresponding to the referred work machine identification information from the storage 105 (step S02). The work machine model TM to be designated may be fixed and the selection of the work machine model TM may be omitted.

Here, the work machine model TM will be described with reference to FIG. 9.

As shown in FIG. 9, the work machine model TM is information which includes the work machine identification information, an outer shape three-dimensional model M0 of the work machine 3 shown in the work machine identification information, an operating panel model M1, and the like. The outer shape three-dimensional model M0 is a three-dimensional model representing the work machine 3 and is constructed for each part of the work machine 3, such as the undercarriage and the upper swing body. For example, the outer shape three-dimensional model M0 represents the shape of the work machine 3. For example, the outer shape three-dimensional model M0 includes an undercarriage outer shape model M01 representing the undercarriage 31 of the work machine 3, an upper swing body outer shape model M02 representing the upper swing body 32, a boom outer shape model M03 representing the boom BM, an arm outer shape model M04 representing the arm AR, and a bucket outer shape model M05 representing the bucket BK.

The operating panel model M1 is a model representing the operating panel of the work machine 3 which is specified by the work machine identification information, and reproduces the input directions and the input degrees to the operating levers L1 and L2 and the traveling levers R1 and R2 by the manipulator of the work machine 3. The operating panel model M1 includes information indicating the correspondence between the operation types (rightward/leftward swing, arm excavation/dump, boom raising/lowering, bucket excavation/dump, right crawler forward movement/backward movement, and left crawler forward movement/backward movement (refer to FIG. 7)) of the work machine 3 and the input operation types (forward operation of the operating lever L1, rightward operation of the operating lever L2, and the like) by the manipulator of the work machine 3.

Returning to FIG. 5, subsequently, the reception unit 1001 receives the reproduction instruction (step S03). One aspect of the reproduction instruction may be an operation such as pressing a reproduction button. Further, the reproduction instruction may include information on a starting point of reproduction such as time, the position of the work machine 3, or events such as occurrence of abnormality in the work machine 3. When receiving the reproduction instruction, the extraction unit 1002 of the CPU 100 extracts the information to be used for reproduction from the log information TL (step S04). For example, information on various angle such as the boom angle, the arm angle, and the bucket angle is extracted as the information to be used for reproduction. The pilot hydraulic pressure shown in FIG. 7 may be extracted as the information to be used for reproduction. Further, in step S01, only the information to be used for reproduction may be acquired.

Subsequently, the CPU 100 draws a movement trajectory of the work machine 3 on a two-dimensional map which is an overhead view image of the work site with reference to the position of the work machine 3 at each time shown in the log information TL. For example, the movement trajectory of the work machine 3 is drawn by sequentially applying the position of the work machine 3 at each time shown in the log information TL, onto the two-dimensional map which is an overhead view image of the work site, in order from the oldest time stamp.

In a case where the reproduction instruction including time is received in step S03, the movement trajectory of the work machine 3 may be drawn by sequentially applying the position of the work machine 3 shown in the log information TL corresponding to the time, onto the two-dimensional map which is an overhead view image of the work site, in order from the oldest time stamp. Further, the movement trajectory of the work machine 3 may be drawn by sequentially applying the position of the work machine 3 shown in the log information TL corresponding to time before a predetermined time from the time, onto the two-dimensional map which is an overhead view image of the work site, in order from the oldest time stamp.

Further, in a case where the reproduction instruction including a position is received in step S03, the movement trajectory of the work machine 3 may be drawn by sequentially applying the position of the work machine 3 shown in the log information TL corresponding to the position, onto the two-dimensional map which is an overhead view image of the work site, in order from the oldest time stamp.

Further, the extraction unit 1002 refers to the status (FIG. 8) of the drive mechanism such as the engine or the hydraulic pump of the work machine 3 at each time shown in the log information TL, and extracts a section (hereinafter, also referred to as an abnormality occurrence section) in which abnormality has occurred in the drive mechanism on the movement trajectory of the work machine 3. The CPU 100 draws the abnormality occurrence section so as to overlap the movement trajectory on the display unit 102 (step S05). In another embodiment, the drawing processing in step S05 may be performed at the timing of step S06 (described later) or at a further subsequent step.

Next, the reproduction unit 1003 executes animation reproduction processing of the work machine model TM (step S06). Here, the reproduction unit 1003 reproduces the work machine 3 by animation while sequentially applying various information recorded in the log information TL to the work machine model TM in order from the oldest time stamp. In a case where the reproduction instruction including time is received in step S03, the work machine 3 is reproduced by animation while sequentially applying various information corresponding to the time to the work machine model TM. Similarly, in a case where the reproduction instruction including a position or various events is received in step S03, the work machine 3 is reproduced by animation while sequentially applying various information corresponding to time at the position and corresponding to time when the various events have occurred to the work machine model TM.

Specifically, the reproduction unit 1003 changes, based on the information on various angle such as the swing angle and the boom angle shown in the log information TL, the angle of a corresponding portion of the outer shape three-dimensional model M0. For example, the reproduction unit 1003 reproduces the position and posture of the bucket BK of the work machine 3 by tilting the bucket outer shape model M05 around a rotation axis which is defined at a connection point with the arm outer shape model M04 so as to have the bucket angle shown in the log information TL.

Similarly, the reproduction unit 1003 reproduces the position and posture of the arm AR of the work machine 3 by tilting the arm outer shape model M04 around a rotation axis which is defined at a connection point with the boom outer shape model M03 so as to have the arm angle shown in the log information TL.

Similarly, the reproduction unit 1003 reproduces the position and posture of the upper swing body 32 of the work machine 3 by tilting the upper swing body outer shape model M02 around a rotation axis which is defined at a connection point with the undercarriage outer shape model M01 so as to have the swing angle shown in the log information TL.

Similarly, the reproduction unit 1003 reproduces the posture of the upper swing body 32 of the work machine 3 by tilting the undercarriage outer shape model M01 around a roll rotation axis which is defined in the undercarriage outer shape model M01 so as to have the roll angle shown in the log information TL and tilting the undercarriage outer shape model M01 around a pitch rotation axis which is defined in the undercarriage outer shape model M01 so as to have the pitch angle shown in the log information TL.

Further, the reproduction device 10 according to the first embodiment can perform the animation reproduction of the traveling of the work machine 3, based on the PPC pressures of the right crawler forward movement/backward movement and the left crawler forward movement/backward movement at each time, which are included in the log information TL.

Specifically, the outer shape three-dimensional model M0 is advanced, retreated, advanced to the left or the right, and retreated to the left or the right, based on the PPC pressures of the right crawler forward movement/backward movement and the left crawler forward movement/backward movement. For example, the outer shape three-dimensional model M0 is moved in a front direction, based on the numerical values of the PPC pressures of the right crawler forward movement and the left crawler forward movement. The moving speed may be changed based on the numerical value of the PPC pressure.

Further, the outer shape three-dimensional model M0 is moved in a rear direction, based on the numerical values of the PPC pressures of the right crawler backward movement and the left crawler backward movement. Further, the outer shape three-dimensional model M0 is moved so as to turn in a curved manner in a front leftward or rightward direction, based on the difference between the numerical values of the PPC pressures of the right crawler forward movement and the left crawler forward movement. For example, when the numerical value of the PPC pressure of the right crawler forward movement is larger than the numerical value of the PPC pressure of the left crawler forward movement, the outer shape three-dimensional model M0 is moved so as to turn in a curved manner in a front leftward direction. The speed of the movement and the size of the curve may be changed according to the numerical values of the respective PPC pressures and the difference between the numerical values of the PPC pressures.

Similarly, the outer shape three-dimensional model M0 is moved so as to turn in a curved manner in a rear leftward or rightward direction, based on the difference between the numerical values of the PPC pressures of the right crawler backward movement and the left crawler backward movement. For example, when the numerical value of the PPC pressure of the right crawler backward movement is larger than the numerical value of the PPC pressure of the left crawler backward movement, the outer shape three-dimensional model M0 is moved so as to turn in a curved manner in a rear leftward direction. The speed of the movement and the size of the curve may be changed according to the numerical values of the respective PPC pressures and the difference between the numerical values of the PPC pressures.

The traveling of the work machine 3 can be animated more accurately by performing reproduction by using the position information in addition to the PPC pressures of the right crawler forward movement/backward movement and the left crawler forward movement/backward movement. In this case, by using the position information, it is possible to more accurately express the speed of movement and position of the work machine 3. Further, by performing animation reproduction of the work machine 3, based on the roll angle, the pitch angle, or both the roll angle and the pitch angle in addition to the PPC pressures of the right crawler forward movement/backward movement and the left crawler forward movement/backward movement, it is possible to reproduce the tilt in the left-right direction of the work machine 3 or the tilt in the front-rear direction of the work machine 3 during traveling.

Further, the reproduction unit 1003 performs animation reproduction of the input operations to various operating levers and the traveling levers by the manipulator of the work machine 3 by sequentially applying the PPC pressures of the operating levers L1 and L2 and the traveling levers R1 and R2 corresponding to the respective operation types, which are shown in the log information TL, to the operating panel model M1 of the work machine model TM, in order from the oldest time stamp. The reproduction unit 1003 simultaneously performs the animation reproduction of the outer shape three-dimensional model M0 and the operating panel model M1 on the same screen while aligning the reproduction times thereof with each other.

The reproduction unit 1003 determines whether or not to end the animation reproduction during the animation reproduction processing of the work machine 3 (step S07). For example, when an instruction to end the reproduction is received as pressing of a stop button or the like, it is determined that the animation reproduction is ended. It may be determined that the animation reproduction is ended after a predetermined period of time has elapsed after the start of the animation reproduction. When the animation reproduction is not ended (step S07; NO), the reproduction unit 1003 continues the animation reproduction of the work machine model TM. On the other hand, when the animation reproduction is ended (step S07; YES), the reproduction unit 1003 ends the animation reproduction processing.

Steps S00, S02, S04, S05, and S07 of the processing flow described using FIG. 5 are not essential configurations of the reproduction device 10, and another embodiment may not necessarily include such steps.

An example in which the reception unit 1001 receives the reproduction instruction and the animation reproduction of the work machine 3 is performed has been described above, but in another embodiment, a reproduction period may be received as the reproduction instruction.

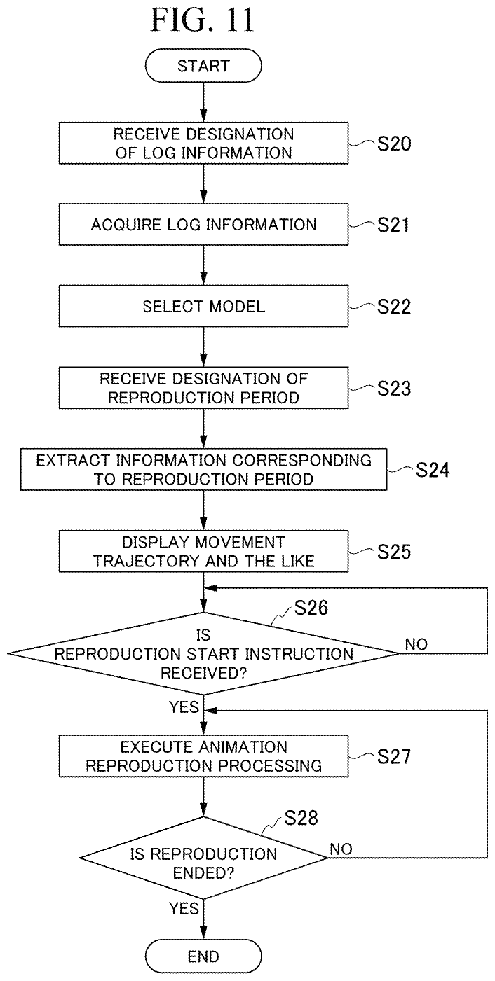

FIG. 11 shows a processing flow of the reproduction device in a case where the reproduction period is received as the reproduction instruction.

When the dedicated application is started by the operation of the operator, the reception unit 1001 of the CPU 100 receives the designation of the log information TL to be reproduced (step S20). The operator of the reproduction device 10 designates the log information TL to be reproduced, by inputting for example, a file name or the like of the log information TL. The log information TL to be reproduced may be fixed, and the designation of the log information TL may be omitted.

Subsequently, when the designation of the log information TL is received from the operator of the reproduction device 10 in step S20, the acquisition unit 1000 of the CPU 100 expands the designated log information TL in the memory 101 and acquires it (step S21). Next, the acquisition unit 1000 refers to the work machine identification information included in the log information TL. The acquisition unit 1000 selects and reads out the work machine model TM corresponding to the referred work machine identification information from the storage 105 (step S22). The work machine model TM to be designated may be fixed and the selection of the work machine model TM may be omitted.

Subsequently, the reception unit 1001 receives a reproduction period (reproduction start time and reproduction end time) as the reproduction instruction from the operator of the reproduction device 10 (step S23). When the reproduction instruction is received, the extraction unit 1002 of the CPU 100 extracts information on the state of the work machine 3 from the reproduction start time to the reproduction end time from the log information TL (step S24).

Subsequently, the CPU 100 draws a movement trajectory of the work machine 3 on a two-dimensional map which is an overhead view image of the work site, with reference to the position (FIG. 6) of the work machine 3 at each time shown in the log information TL. Further, the extraction unit 1002 refers to the status (FIG. 8) related to the drive mechanism such as the engine or the hydraulic pump of the work machine 3 at each time shown in the log information TL and extracts a section (hereinafter, also referred to as an abnormality occurrence section) in which abnormality has occurred in the drive mechanism on the movement trajectory of the work machine 3. The CPU 100 draws the abnormality occurrence section so as to overlap the movement trajectory on the display unit 102 (step S25). In another embodiment, the drawing processing of the abnormality occurrence section in step S25 may be performed at the timing of step S27 (described later), or at a further subsequent step.

Subsequently, the reproduction unit 1003 of the CPU 100 determines whether or not an instruction to start the reproduction has been received from the operator of the reproduction device 10 (step S26). When the instruction to start the reproduction is not received (step S26; NO), waiting is performed until the instruction to start the reproduction is received. When the instruction to start the reproduction is received (step S26; YES), the reproduction unit 1003 executes the animation reproduction processing of the work machine model TM (step S27). Here, the reproduction unit 1003 performs animation reproduction of the work machine 3 while sequentially applying the information extracted in S24 to the work machine model TM in order from the oldest time stamp.

Next, the reproduction unit 1003 determines whether or not the animation reproduction is ended during the animation reproduction processing of the work machine 3 (step S28). When the animation reproduction is not ended (step S28; NO), the reproduction unit 1003 continues the animation reproduction of the work machine model TM. On the other hand, when the animation reproduction is ended (step S28; YES), the reproduction unit 1003 ends the animation reproduction processing. The reproduction unit 1003 ends the animation reproduction processing, for example, when the animation stop operation by the operator of the reproduction device 10 is received, or when the reproduction time has reached the reproduction end time.

Steps S20, S22, S25, S26, and S28 of the processing flow described using FIG. 11 are not essential configurations of the reproduction device 10, and another embodiment may not necessarily include such steps.

### (Display Screen of Reproduction Device)

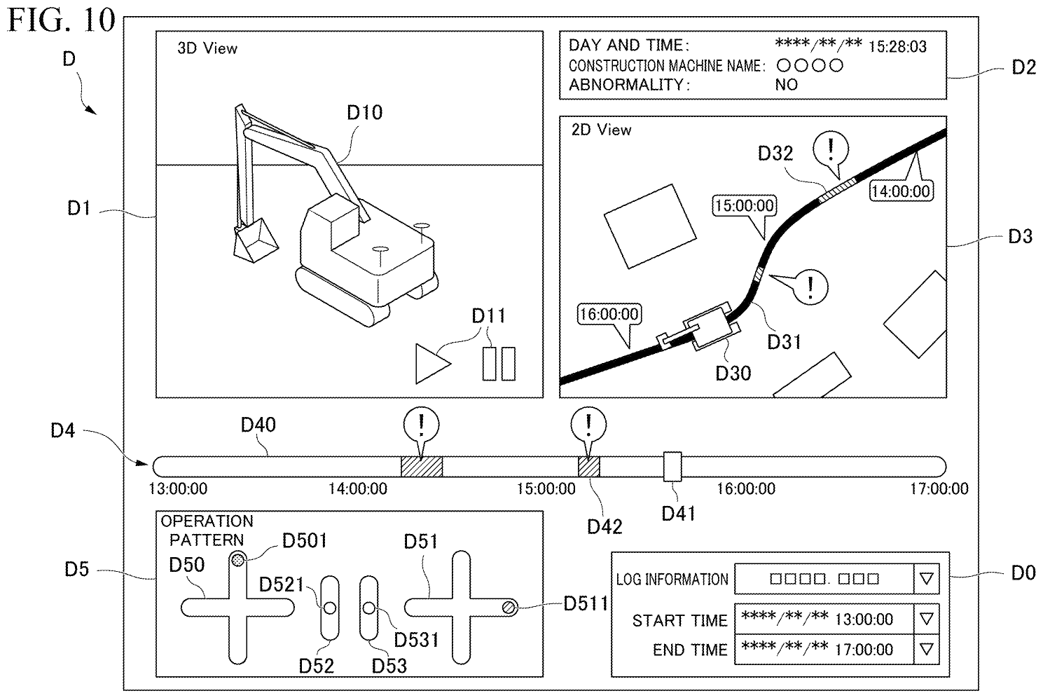

FIG. 10 is a diagram showing an example of a display screen of the reproduction device according to the first embodiment.

The CPU 100 of the reproduction device 10 according to the first embodiment causes the display unit 102 to display a display image D as shown in FIG. 10, for example.

The display image D is configured to include an input form D0, an outer shape three-dimensional model display image D1, an information list image D2, a two-dimensional map image D3, a time scroll bar D4, and an operation pattern image D5.

The input form D0 is an area in which an image used for receiving the designation of the log information TL and the reproduction period (start time and end time) from the operator of the reproduction device 10 is drawn. The operator of the reproduction device 10 inputs desired information in the input form D0. For example, in a case of designating the log information TL, the file name of the log information TL is input. Further, in a case of designating the reproduction start time and end time, the start time and the end time are input.

The outer shape three-dimensional model display image D1 is an area in which the outer shape three-dimensional model M0 is reproduced by animation. A work machine image D10 obtained by applying various information such as the boom angle, the arm angle, and the bucket angle, which show the state of the work machine 3, to the outer shape three-dimensional model M0 is drawn on the outer shape three-dimensional model display image D1. Further, a button image D11 for the operator of the reproduction device 10 to instruct the animation reproduction, pause, or the like is drawn on the outer shape three-dimensional model display image D1.

The information list image D2 is an area for presenting various information on the reproduction to the operator of the reproduction device 10. The information list image D2 includes the reproduction time, the vehicle type and model of the work machine model TM which is being reproduced, the presence or absence of abnormality at the reproduction time, and the like.

The two-dimensional map image D3 is an area in which an overhead view image of the work machine 3 is drawn. In addition to the two-dimensional map image which is an overhead view image of the work site, a work machine icon D30, a movement trajectory D31, and an abnormality occurrence section D32 are drawn on the two-dimensional map image D3.

The work machine icon D30 is an image showing the position and direction of the work machine 3 which is being reproduced on the two-dimensional map.

The movement trajectory D31 shows the movement trajectory of the work machine 3 on the two-dimensional map. The work machine icon D30 and the movement trajectory D31 are drawn based on the position of the work machine 3 at each time included in the log information TL.

Further, the abnormality occurrence section D32 shows a section, on the movement trajectory D31, in which abnormality has occurred in the drive mechanism such as the engine or hydraulic pump of the work machine 3. The abnormality occurrence section D32 is drawn based on the status (FIG. 8) of the drive mechanism of the work machine 3. For example, the CPU 100 extracts a section in which the cooling water temperature of the engine exceeds a predetermined abnormality determination threshold value from the movement trajectory D31 of the work machine 3, and draws the section as the abnormality occurrence section D32.

The operator of the reproduction device 10 may change the reproduction time as desired, for example, by performing a clicking operation or the like using the operation reception unit 103 such as a mouse to designate a position on the movement trajectory D31.

The time scroll bar D4 is a scroll bar for controlling the animation reproduction. A bar image D40 showing the time axis from the start time to the end time, a reproduction time icon D41 corresponding to the reproduction time in the time axis shown by the bar image D40, and an abnormality occurrence time zone D42 are drawn on the time scroll bar D4. The reproduction time icon D41 is displayed at a position corresponding to the reproduction time on the bar image D40. The operator can change the reproduction time as desired, by performing an operation of sliding the reproduction time icon D41 on the bar image D40.

The abnormality occurrence time zone D42 is a time zone corresponding to the abnormality occurrence section D32 on the two-dimensional map image D3 and shows a time zone in which abnormality has occurred in the drive mechanism of the work machine 3 from the start time to the end time.

The operator of the reproduction device 10 may change the reproduction time as desired, by performing an operation of sliding the reproduction time icon D41 on the bar image D40 by using the operation reception unit 103.

The operation pattern D5 is an area in which the input operations to the operating levers and the traveling levers by the manipulator of the work machine 3 are reproduced by animation. The operation pattern D5 includes operation images D50, D51, D52, and D53 and operation icons D501, D511, D521, and D531.

Specifically, the operation image D50 is an area in which the input operation to the operating lever L1, which is the operating lever on the left side, is reproduced by animation. The position of the operation icon D501 on the operation image D50 indicates the input direction to the operating lever L1. Further, the color of the operation icon D501 which is displayed on the operation image D50 indicates the degree of input to the operating lever L1. For example, the icon D501 is displayed in complete “white” when there is no input to the operating lever L1, and is displayed so as to change from “white” to “red” as the degree of input increases. The combination of colors that change according to the degree of input is not limited to this example. The same applies to the icons D511, D521, and D531 which will be described later.

The operation image D51 is an area in which the input operation to the operating lever L2, which is the operating lever on the right side, is reproduced by animation. The position of the operation icon D511 on the operation image D51 indicates the input direction to the operating lever L2. Further, the color of the operation icon D511 which is displayed on the operation image D51 indicates the degree of input to the operating lever L2.

The operation image D52 is an area in which the input operation to the traveling lever R1, which is the traveling lever on the left side, is reproduced by animation. The position of the operation icon D521 on the operation image D52 indicates the input direction to the traveling lever R1. Further, the color of the operation icon D521 which is displayed on the operation image D52 indicates the degree of input to the traveling lever R1.

The operation image D53 is an area in which the input operation to the traveling lever R2, which is the traveling lever on the right side, is reproduced by animation. The position of the operation icon D531 on the operation image D53 indicates the input direction to the traveling lever R2. Further, the color of the operation icon D531 which is displayed on the operation image D53 indicates the degree of input to the traveling lever R2.

### (Operation and Effects)

As described above, the reproduction device 10 according to the first embodiment includes the acquisition unit 1000 that acquires the log information TL that includes the angle information of the movable part of the work machine 3, which is associated with time, the reception unit 1001 that receives the reproduction instruction of reproducing the movement of the work machine 3, and the reproduction unit 1003 that reproduces the operation of the work machine 3 by sequentially applying the angle information of the movable part of the work machine 3 to the work machine model TM when receiving the reproduction instruction.

According to this configuration, the movement in the designated time zone among a series of movements performed by the work machine 3 at the actual work site is reproduced using the work machine model TM, based on the log information TL. Therefore, it is possible to analyze the work by the manipulator of the work machine 3 in detail.

In particular, the reproduction device 10 according to the first embodiment performs the animation reproduction of the outer shape three-dimensional model M0 showing the shape of the work machine 3, based on the information that is included in the log information TL and is capable of specifying the position and posture of each part of the work machine 3. In this way, since the movement of the outer shape of the work machine 3 at the actual work site is reproduced by the three-dimensional model representing the work machine 3, the work performed by the work machine 3 at the work site can be analyzed in detail.

Further, the reproduction device 10 according to the first embodiment performs the animation reproduction of the operating panel model M1 showing the operating mechanisms of the work machine 3, based on the PPC pressures that are included in the log information TL and show the degrees of input to the operating mechanisms such as the operating levers L1 and L2 and the traveling levers R1 and R2. In this way, since the operation state of the manipulator of the work machine 3 at the actual work site is reproduced by the operating panel model M1 representing the operating mechanisms of the work machine 3, it is possible to analyze the operation performed by the manipulator of the work machine 3 at the work site in detail after the fact.

Further, the reproduction device 10 simultaneously reproduces the outer shape three-dimensional model and the operating panel model M1 while aligning the reproduction times thereof with each other. In this way, it is possible to analyze the correspondence relationship between the input operation by the manipulator and the movement of the outer shape of the work machine 3 based on the input operation.

Further, the reproduction device 10 according to the first embodiment extracts the abnormality occurrence time zone showing the time zone in which the state of the work machine 3 has become abnormal, from the log information TL, and displays it on, for example, the time scroll bar D4 or the like. In this way, the operator of the reproduction device 10 can easily grasp the time zone in which abnormality has occurred in the work machine 3. The operator can analyze the cause of the occurrence of abnormality by designating the displayed abnormality occurrence time zone to be included in the reproduction period to perform reproduction.

Further, the reproduction device 10 according to the first embodiment reproduces a change in the position of the work machine 3 on the two-dimensional map, based on the position of the work machine 3 at each time included in the log information TL. In this way, it is possible to grasp in detail the change in the position of the work machine 3 at the work site.

Further, the reproduction device 10 displays the section in which abnormality has occurred in the work machine 3 on the movement trajectory D31. In this way, it is possible to analyze at what position in the work site the abnormality has occurred.

The reproduction device 10 and the analysis assistance system 1 provided with the reproduction device 10 according to the first embodiment have been described in detail above, but the present invention is not limited to the aspect in another embodiment.

The contents (FIGS. 6 to 8) of the log information TL according to the first embodiment are not limited to these in another embodiment. For example, in a case where the work machine 3 is not a hydraulic excavator but another vehicle type, log information TL corresponding to the vehicle type is recorded. Another vehicle type is, for example, a wheel loader or the like.

Similarly, as the work machine model TM according to the first embodiment, a work machine model representing the outer shape and operating panel of the work machine 3 is prepared for each vehicle type or model of the work machine 3.

Further, the example has been described in which the log information TL according to the first embodiment includes the position of the work machine 3, the angles of various movable parts (FIG. 6), the PPC pressures in the operating mechanisms (FIG. 7), and the status of the drive mechanism (FIG. 8) of the work machine 3, at each time. However, in another embodiment, there is no limitation thereto.

The reproduction device 10 according to another embodiment may acquire only the information in FIG. 6 as the log information TL. In this case, the reproduction device 10 reproduces only the movement of the work machine 3 by animation, based on the log information TL. Further, the reproduction device 10 may acquire only the information in FIG. 7 as the log information TL. In this case, the reproduction device 10 can performs animation reproduction of the traveling of the work machine 3 and the input operations to various operating levers and traveling levers of the work machine 3, based on the log information TL.

Further, the reproduction device 10 according to the first embodiment has been described as including both the outer shape three-dimensional model M0 and the operating panel model M1 as the work machine model TM and reproducing both the outer shape three-dimensional model M0 and the operating panel model M1, but the present invention is not limited to the aspect in another embodiment. In another embodiment, the work machine model TM may include either one of the outer shape three-dimensional model M0 and the operating panel model M1, and the reproduction device 10 may reproduce only the one of the outer shape three-dimensional model M0 and the operating panel model M1. Further, the reproduction device 10 may be configured to switch between reproducing the outer shape three-dimensional model M0 and the operating panel model M1.

Further, the reproduction device 10 according to the first embodiment has been described as reproducing a change in the position of the work machine 3 on the two-dimensional map, but the present invention is not limited to the aspect in another embodiment. The reproduction device 10 according to another embodiment may not necessarily reproduce a change in the position of the work machine 3 on the two-dimensional map.

Further, the reproduction device 10 according to the first embodiment has been described as displaying the abnormality occurrence section on the two-dimensional map and the abnormality occurrence time zone on the time scroll bar, but the present invention is not limited to the aspect in another embodiment The reproduction device 10 according to another embodiment may not necessarily display the abnormality occurrence section on the two-dimensional map or the abnormality occurrence time zone on the time scroll bar.

Further, the reproduction device 10 according to another embodiment may have not only normal speed reproduction but also fast forward, slow reproduction, repeat, and rewind functions.

For example, in a case of performing reproduction using 15 pieces of angle information or the like per second in the normal reproduction, the reproduction unit 1003 realizes a double-speed fast-forward function by performing reproduction using 30 pieces of angle information or the like per second, or by skipping 15 pieces of angle information or the like per second. A triple-speed fast-forward function or the like can also be realized by the same mechanism.

Similarly, in a case of performing reproduction using 15 pieces of angle information or the like per second in the normal reproduction, the reproduction unit 1003 realizes a half-speed slow reproduction function by reproducing 15 pieces of angle information or the like over 2 seconds. In particular, by enabling slow reproduction of the operation pattern image D5 (FIG. 10), a trainee can grasp the lever operation technique of an expert in more detail.

Similarly, in a case of performing reproduction by sequential application from the oldest time stamp in the normal reproduction, the rewind reproduction is realized by performing reproduction by sequential application from the newest time stamp.

Further, in the operating mechanisms such as the operating levers L1 and L2 and the traveling levers R1 and R2 according to the first embodiment, the degree of input to each operating mechanism has been described as being expressed by the PPC pressure, but the present invention is not limited to the aspect in another embodiment.

For example, the operating mechanism according to another embodiment may be an electric operating mechanism. In this case, the operating mechanism may have an operating member such as an electric lever, and an operating amount sensor such as a potentiometer inclinometer that electrically detects the tilt amount of the operating member. In this embodiment, the detection data of the operating amount sensor is recorded in the data logger 20.

Further, the reproduction device 10 according to the first embodiment has been described as representing the work machine 3 with the outer shape three-dimensional model M0, but the present invention is not limited to the aspect in another embodiment. The reproduction device 10 according to another embodiment may represent the work machine 3 with a two-dimensional model, for example.

Further, the reproduction device 10 according to the first embodiment has been described as expressing the degree of input to the operating mechanism by the manipulator with a change in color of the icon D501 or the like shown on the operation pattern D5, but the present invention is not limited to the aspect in another embodiment. For example, the reproduction device according to another embodiment may express the degree of input with a position where the icon D501 or the like is drawn. For example, in the reproduction device 10, the icon D501 is drawn at a position close to the center of the operation image D50 when the degree of input to the operating lever L1 is small, and the icon D501 is drawn at a position farther from the center of the operation image D50 as the degree of input to the operating lever L1 increases.

Further, in another embodiment, the degree of input may be shown by the gradation strength of a color which is drawn in the operation image D50.

Further, the reproduction device 10 according to the first embodiment has been described as being installed at a place away from the work machine 3 and being connected to the data logger 20 mounted on the work machine 3 through the wide area communication network, but the present invention is not limited to the aspect in another embodiment.

For example, in the reproduction device 10 according to another embodiment, part or the entire configuration of the reproduction device 10 may be installed inside the work machine 3. In this case, the data logger 20 may transmit the log information TL to the reproduction device 10 through a network or the like inside the work machine 3 without going through the wide area communication network. In this way, the manipulator who boards the work machine 3 can confirm the movement of the work machine 3 which is operated by the manipulator himself by animation reproduction on the spot. Further, by reproducing the movement of the work machine 3, which becomes a model for the manipulator of the work machine 3, the manipulator can use it as guidance.

The reproduction device 10 installed inside the work machine 3 may acquire the log information TL of another work machine 3 through the wide area communication network or the like. In this case, it is possible to perform animation reproduction of the state of the other work machine 3 than the work machine 3 on which the reproduction device 10 is mounted.

Further, the reproduction device 10 according to another embodiment may be installed at a place away from the work machine 3 and video information generated by the animation reproduction processing may be transmitted to and displayed on a monitor mounted on the work machine 3.

Further, in another embodiment, as an aspect of the reproduction instruction which is received from the operator, the position of the work machine 3 displayed on the screen on the two-dimensional map may be designated. In this case, the reproduction device 10 performs the reproduction of the work machine 3 with the time when the work machine 3 exists at the position designated by the operator as the reproduction start time.

Further, the processing flow in a case where the designation of the reproduction period (reproduction start time and reproduction end time) is received has been described. However, in another embodiment, the designation of the reproduction end time is not essential. For example, in another embodiment, an aspect may be adopted in which only the reproduction start time is received as the reproduction instruction from the operator and reproduction is performed for a certain period of time from the reproduction start time, an aspect may be adopted in which the reproduction is continued as long as the log information exists, or an aspect may be adopted in which the reproduction is stopped when various other events occur.

The log information TL (FIGS. 6 to 8) to be acquired does not need to be arranged in chronological order. In this case, the reproduction unit 1003 may apply information to be used for reproduction, which is included in the log information TL, to the work machine model TM in chronological order.

Procedures of various processes of the reproduction device 10 described above are stored in a computer-readable recording medium in a program format, and a computer reads and executes the program to perform the various processes. Examples of the computer-readable recording medium include a magnetic disk, a magneto-optical disc, a CD-ROM, a DVD-ROM, and a semiconductor memory. The computer program may be delivered to a computer via a communication line, and the computer received the computer program may execute the program.

The program may realize some of the functions described above. Further, the program may be a so-called difference file or difference program which can realize the functions described above through in combination with a program which is already recorded in a computer system.

Although some embodiments of the present invention have been described above, these embodiments have been presented as examples and are not intended to limit the scope of the invention. These embodiments can be implemented in other various forms, and various omissions, alterations, and changes can be made within the scope without departing from the gist of the invention. These embodiments or modifications thereof are included in the scope or gist of the invention and are also included in the scope of the invention described in the claims and the equivalents thereof.

According to the present invention, the movement of the work machine based on the operation of the manipulator can be reproduced and analyzed on a screen.

1. A reproduction device comprising:
an acquisition unit that acquires log information including angle information of a movable part of a work machine, the log information being associated with time;
a reception unit that receives a reproduction instruction usable to reproduce a movement of the work machine; and
a reproduction unit that reproduces the movement of the work machine by sequentially applying the angle information to a work machine model upon receiving the reproduction instruction.

2. The reproduction device according to claim 1, wherein
the reproduction unit stops the reproduction of the movement of the work machine upon receiving an instruction to end the reproduction.

3. The reproduction device according to claim 1, further comprising;
an extraction unit,
the reproduction instruction including a reproduction period,
the extraction unit extracting the angle information corresponding to the reproduction period from the log information, and
the reproduction unit sequentially applying the extracted angle information to the work machine model.

4. The reproduction device according to claim 1, wherein
the work machine model includes a three-dimensional model showing the work machine.

5. The reproduction device according to claim 4, wherein
the work machine model further includes an operating panel model showing an operating mechanism of the work machine.

6. The reproduction device according to claim 5, wherein
the reproduction unit simultaneously reproduces the three-dimensional model and the operating panel model while aligning reproduction times thereof with each other.

7. The reproduction device according to claim 5, wherein
the reproduction unit is capable of performing slow reproduction of the three-dimensional model and the operating panel model.

8. The reproduction device according to claim 3, wherein
the extraction unit further extracts the angle information corresponding to a period in which a state of the work machine becomes abnormal from the log information.

9. The reproduction device according to claim 1, wherein
the reproduction unit reproduces a change in position of the work machine on a two-dimensional map, based on the angle information.

10. The reproduction device according to claim 1, wherein
the acquisition unit acquires log information that includes a boom angle, an arm angle, and a bucket angle of the work machine, which is provided with a boom, an arm, and a bucket; and
the reproduction unit reproduces the movement of the work machine by sequentially applying the boom angle, the arm angle, and the bucket angle to the work machine model.

11. An analysis assistance system comprising:
an acquisition unit that acquires log information including angle information of a movable part of a work machine, the log information being associated with time;
a reception unit that receives a reproduction instruction usable to reproduce a movement of the work machine; and
a reproduction unit that reproduces the movement of the work machine by sequentially applying the angle information to a work machine model upon receiving the reproduction instruction.

12. A reproduction method comprising:
acquiring log information including angle information of a movable part of a work machine, the log information being associated with time;
receiving a reproduction instruction usable to reproduce a movement of the work machine; and
reproducing the movement of the work machine by sequentially applying the angle information to a work machine model upon receiving the reproduction instruction.
